(19) United States
(12) Patent Application Publication
(10) Pub. No.: US 2026/0155004 A1
(43) Pub. Date: Jun. 4, 2026

(54) SECURED GARAGE DOOR OPENER

(71) Applicant: Teresa Brown, Palmdale, CA (US)

(72) Inventor: Teresa Brown, Palmdale, CA (US)

(21) Appl. No.: 18/964,390

(22) Filed: Nov. 30, 2024

(51) Int. Cl. G07C 9/00

(52) U.S. Cl. CPC G07C 9/00563; G07C 9/00182; G07C 9/00896; G07C 2009/00214; G07C 2009/00928

(57) ABSTRACT

A secured garage door opener to open a garage door, the secured garage door opener including a main body, a garage door opening button disposed on the main body to open the garage door when the garage door opening button is pressed, a garage door closing button disposed on the main body to close the garage door when the garage door closing button is pressed, and a fingerprint scanner disposed on the main body to prevent the garage door opening button from opening the garage door unless an authorized fingerprint is detected by the fingerprint scanner.

### BACKGROUND

### 1. Field

The present general inventive concept relates generally to a garage door opener, and particularly, to a secured garage door opener.

### 2. Description of the Related Art

Managing access to garages via a primary door allows thieves to break into a home relatively easily, as current garage doors' safety release mechanisms can be activated outside the door with often a press of a button or with use of tools that can manipulate a control panel.

As garages are not only used for car parking, many people have concerns regarding the safety of their designated storage area or casual living room/gathering space within their household.

Therefore, there is a need for an improved device that allows for more secure access to a garage.

### SUMMARY

The present general inventive concept provides a secured garage door opener.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a secured garage door opener to open a garage door, the secured garage door opener including a main body, a garage door opening button disposed on the main body to open the garage door when the garage door opening button is pressed, a garage door closing button disposed on the main body to close the garage door when the garage door closing button is pressed, and a fingerprint scanner disposed on the main body to prevent the garage door opening button from opening the garage door unless an authorized fingerprint is detected by the fingerprint scanner.

The foregoing and/or other features and utilities of the present general inventive concept may be achieved by providing a secured garage door opener to open a garage door, the secured garage door opener including a main body, a garage door opening button disposed on the main body to open the garage door when the garage door opening button is pressed, a garage door closing button disposed on the main body to close the garage door when the garage door closing button is pressed, and a camera disposed on the main body to prevent the garage door opening button from opening the garage door unless an authorized face is detected by the camera.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric perspective view of a secured garage door opener, according to an exemplary embodiment of the present general inventive concept;

FIG. 2 illustrates an isometric perspective view of a secured garage door opener, according to another exemplary embodiment of the present general inventive concept; and

FIG. 3 illustrates an isometric perspective view of a secured garage door opener, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Secured Garage Door Opener 100
Main Body 110
Garage Door Opening Button 120
Garage Door Closing Button 130
Fingerprint Scanner 140
Camera 150
Central Processing Unit (CPU) 160
Secured Garage Door Opener 200
Main Body 210
Sliding Cover 211
Garage Door Opening Button 220
Garage Door Closing Button 230
Fingerprint Scanner 240
Camera 250
Keypad 260
Central Processing Unit (CPU) 270
Secured Garage Door Opener 300
Main Body 310
Garage Door Opening and Closing Button 320
Fingerprint Scanner 330
Camera 340
Central Processing Unit (CPU) 350

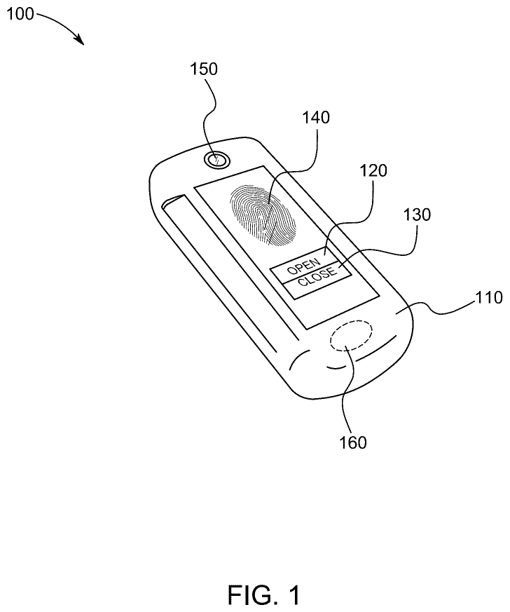

FIG. 1 illustrates an isometric perspective view of a secured garage door opener 100, according to an exemplary embodiment of the present general inventive concept.

The secured garage door opener 100, and all components therein and/or connected thereto, may be constructed from at least one of metal, plastic, stone, ceramics, wood, silicone, glass, paper, cloth, circuitry, leather, memory foam, latex, and rubber, etc., but is not limited thereto, and can be constructed from any material known to one of ordinary skill in the art.

Referring to FIG. 1, the secured garage door opener 100 is illustrated as a hand-held garage door opener that may be kept in a vehicle, stored within a home, and/or transported to any location desired by a user. As such, the secured garage door opener 100 may be designed to be able to communicate with any automatic garage door opening device and/or assembly that is attached and/or connected (i.e., electrically and/or physically connected) to a garage door of a garage (not illustrated).

Referring to FIG. 1, the secured garage door opener 100 may include a main body 110, a garage door opening button 120, a garage door closing button 130, a fingerprint scanner 140, a camera 150, and a central processing unit (CPU) 160, but is not limited thereto.

The main body 110 may have the garage door opening button 120, the garage door closing button 130, the fingerprint scanner 140, and the camera 150 disposed thereupon, and may have the CPU 160 disposed therewithin.

The garage door opening button 120 may control a garage door to open, and the garage door closing button 130 may control the garage door to close. Although FIG. 1 illustrates the garage door opening button 120 and the garage door closing button 130 as two separate buttons, the garage door opening button 120 and the garage door closing button 130 may be combined into one button based on a preference of a manufacturer.

The fingerprint scanner 140 may be programmed to recognize when an authorized user places a finger on the fingerprint scanner 140, such that the garage door will open only upon recognition of a user's authorized fingerprint when the authorized user places a finger on the fingerprint scanner 140. In other words, the fingerprint scanner 140 may be a scanner to detect (a.k.a., read) a fingerprint of a finger of a user that is placed upon the fingerprint scanner 140, such that the fingerprint scanner then allows the garage door to open if an authorized user's fingerprint is detected.

The camera 150 may be programmed to recognize a face of an authorized user, such that the garage door will open only when the camera 150 recognizes an authorized user's face.

The CPU 160 may include electronic circuitry to carry out instructions of a computer program by performing basic arithmetic, logical, control and input/output (I/O) operations specified by the instructions. The CPU 160 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 160 may also include a microprocessor and a microcontroller. The CPU 160 may be a local computer device, a remote server, or cloud computing device.

The CPU 160 may also include a storage unit, a random access memory (RAM), a read-only memory (ROM), a hard disk, a flash drive, a database connected to the Internet, cloud-based storage, Internet-based storage, or any other type of storage unit.

The CPU 160 may access the Internet via an internal communication unit to allow the CPU 160 to access a website, and/or may allow for communication with a mobile application and/or a software application. For ease of description, the mobile and/or the software application will be hereinafter referred to as an app. The app may be downloaded from the Internet to be stored on the storage unit of the CPU 160, and may communicate with a mobile device which also has the app running thereupon.

The CPU 160 may also have a global positioning service (GPS) device installed therein, to allow the CPU 160 to be located via a GPS signal.

The CPU 160 may allow the fingerprint scanner 140 to be programmed (via a mobile device, for example) to recognize a predetermined fingerprint of a user, such that the garage door will open only upon recognition of a user's authorized fingerprint when the authorized user places a finger on the fingerprint scanner 140.

The CPU 160 may also allow the camera 150 to be programmed (via a mobile device, for example) to recognize a face of an authorized user, such that the garage door will open only when the camera 150 recognizes an authorized user's face.

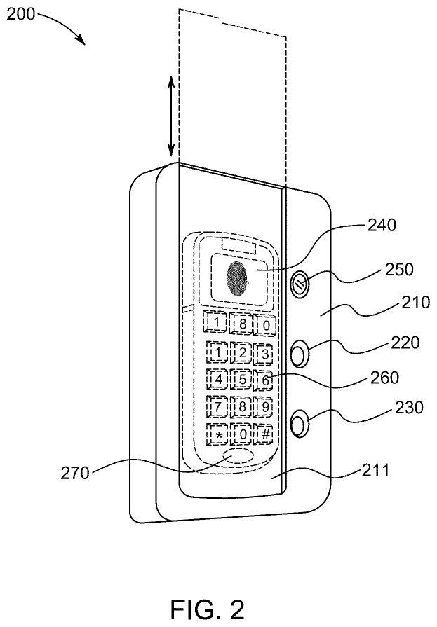

FIG. 2 illustrates an isometric perspective view of a secured garage door opener 200, according to another exemplary embodiment of the present general inventive concept.

The secured garage door opener 200, and all components therein and/or connected thereto, may be constructed from at least one of metal, plastic, stone, ceramics, wood, silicone, glass, paper, cloth, circuitry, leather, memory foam, latex, and rubber, etc., but is not limited thereto, and can be constructed from any material known to one of ordinary skill in the art.

Referring to FIG. 2, the secured garage door opener 200 is illustrated as a garage door opener installed and/or fixed on an outer wall (or inner wall) of a house of a user. As such, the secured garage door opener 200 may be designed to be able to communicate with any automatic garage door opening device and/or assembly that is attached and/or connected (i.e., electrically and/or physically connected) to a garage door of a garage (not illustrated).

Referring to FIG. 2, the secured garage door opener 200 may include a main body 210, a garage door opening button 220, a garage door closing button 230, a fingerprint scanner 240, a camera 250, a keypad 260, and a central processing unit (CPU) 270, but is not limited thereto.

The main body 210 may include a sliding cover 211, which may slide up and down to expose and/or cover the keypad 260.

The main body 210 may have the garage door opening button 220, the garage door closing button 230, the fingerprint scanner 240, the camera 250, and the keypad 260 disposed thereupon, and may have the CPU 270 disposed therewithin.

The garage door opening button 220 may control a garage door to open, and the garage door closing button 230 may control the garage door to close. Although FIG. 2 illustrates the garage door opening button 220 and the garage door closing button 230 as two separate buttons, the garage door opening button 220 and the garage door closing button 230 may be combined into one button based on a preference of a manufacturer.

The fingerprint scanner 240 may be programmed to recognize when an authorized user places a finger on the fingerprint scanner 240, such that the garage door will open only upon recognition of a user's authorized fingerprint when the authorized user places a finger on the fingerprint scanner 240.

In other words, the fingerprint scanner 240 may be a scanner to detect (a.k.a., read) a fingerprint of a finger of a user that is placed upon the fingerprint scanner 240, such that the fingerprint scanner then allows the garage door to open if an authorized user's fingerprint is detected.

The camera 250 may be programmed to recognize a face of an authorized user, such that the garage door will open only when the camera 250 recognizes an authorized user's face.

The keypad 260 may include a numbered keypad that may allow a user to type in (i.e., input) a secret code, such that the garage door will open only when the correct (i.e., authorized) code is input.

The CPU 270 may include electronic circuitry to carry out instructions of a computer program by performing basic arithmetic, logical, control and input/output (I/O) operations specified by the instructions. The CPU 270 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 270 may also include a microprocessor and a microcontroller. The CPU 270 may be a local computer device, a remote server, or cloud computing device.

The CPU 270 may also include a storage unit, a random access memory (RAM), a read-only memory (ROM), a hard disk, a flash drive, a database connected to the Internet, cloud-based storage, Internet-based storage, or any other type of storage unit.

The CPU 270 may access the Internet via an internal communication unit to allow the CPU 270 to access a website, and/or may allow for communication with a mobile application and/or a software application. For ease of description, the mobile and/or the software application will be hereinafter referred to as an app. The app may be downloaded from the Internet to be stored on the storage unit of the CPU 270, and may communicate with a mobile device which also has the app running thereupon.

The CPU 270 may also have a global positioning service (GPS) device installed therein, to allow the CPU 270 to be located via a GPS signal.

The CPU 270 may allow the fingerprint scanner 240 to be programmed (via a mobile device, for example) to recognize a predetermined fingerprint of a user, such that the garage door will open only upon recognition of a user's authorized fingerprint when the authorized user places a finger on the fingerprint scanner 240.

The CPU 270 may also allow the camera 250 to be programmed (via a mobile device, for example) to recognize a face of an authorized user, such that the garage door will open only when the camera 250 recognizes an authorized user's face.

The CPU 270 may further allow the keypad 260 to be programmed with a predetermined code, such that the garage door will open only when the correct (i.e., authorized) code is input into the keypad 260.

When the CPU 720 has determined that an authorized user is manipulating the keypad 260 (via fingerprint recognition, facial recognition, etc.), the CPU 270 may also allow the keypad 260 to be programmed with a schedule, such that the CPU 270 determines whether a garage door is open at a particular time, and if the garage door is open at a particular time, the CPU 270 controls the garage door to close. However, the CPU 270 specifically determines whether the garage door is open prior to triggering the garage door to close, and does not simply trigger the garage door at a particular time.

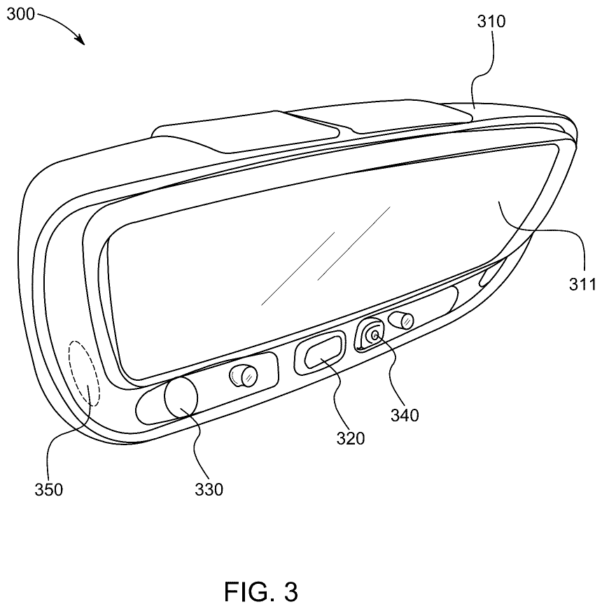

FIG. 3 illustrates an isometric perspective view of a secured garage door opener 300, according to another exemplary embodiment of the present general inventive concept.

The secured garage door opener 300, and all components therein and/or connected thereto, may be constructed from at least one of metal, plastic, stone, ceramics, wood, silicone, glass, paper, cloth, circuitry, leather, memory foam, latex, and rubber, etc., but is not limited thereto, and can be constructed from any material known to one of ordinary skill in the art.

Referring to FIG. 3, the secured garage door opener 300 is illustrated as a rear-view mirror that may be disposed within a vehicle, and which includes components that allow a user to open a garage door. As such, the secured garage door opener 300 may be designed to be able to communicate with any automatic garage door opening device and/or assembly that is attached and/or connected (i.e., electrically and/or physically connected) to a garage door of a garage (not illustrated).

Referring to FIG. 3, the secured garage door opener 300 may include a main body 310, a garage door opening and closing button 320, a fingerprint scanner 330, a camera 340, and a central processing unit (CPU) 350, but is not limited thereto.

The main body 310 may include a mirror 311 disposed thereupon.

The main body 310 may have the garage door opening and closing button 320, the fingerprint scanner 330, and the camera 340 disposed thereupon, and may have the CPU 350 disposed therewithin.

The garage door opening and closing button 320 may control a garage door to open and close.

The fingerprint scanner 330 may be programmed to recognize when an authorized user places a finger on the fingerprint scanner 330, such that the garage door will open only upon recognition of a user's authorized fingerprint when the authorized user places a finger on the fingerprint scanner 330.

In other words, the fingerprint scanner 330 may be a scanner to detect (a.k.a., read) a fingerprint of a finger of a user that is placed upon the fingerprint scanner 330, such that the fingerprint scanner then allows the garage door to open if an authorized user's fingerprint is detected.

The camera 340 may be programmed to recognize a face of an authorized user, such that the garage door will open only when the camera 340 recognizes an authorized user's face.

The camera 340 may also allow a user to see whether the garage door is open and/or closed.

The CPU 350 may include electronic circuitry to carry out instructions of a computer program by performing basic arithmetic, logical, control and input/output (I/O) operations specified by the instructions. The CPU 350 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 350 may also include a microprocessor and a microcontroller. The CPU 350 may be a local computer device, a remote server, or cloud computing device.

The CPU 350 may also include a storage unit, a random access memory (RAM), a read-only memory (ROM), a hard disk, a flash drive, a database connected to the Internet, cloud-based storage, Internet-based storage, or any other type of storage unit.

The CPU 350 may access the Internet via an internal communication unit to allow the CPU 350 to access a website, and/or may allow for communication with a mobile application and/or a software application. For ease of description, the mobile and/or the software application will be hereinafter referred to as an app. The app may be downloaded from the Internet to be stored on the storage unit of the CPU 350, and may communicate with a mobile device which also has the app running thereupon.

The CPU 350 may also have a global positioning service (GPS) device installed therein, to allow the CPU 350 to be located via a GPS signal.

The CPU 350 may allow the fingerprint scanner 330 to be programmed (via a mobile device, for example) to recognize a predetermined fingerprint of a user, such that the garage door will open only upon recognition of a user's authorized fingerprint when the authorized user places a finger on the fingerprint scanner 330.

The CPU 350 may also allow the camera 340 to be programmed (via a mobile device, for example) to recognize a face of an authorized user, such that the garage door will open only when the camera 340 recognizes an authorized user's face.

The present general inventive concept may include a secured garage door opener 100 to open a garage door, the secured garage door opener 100 including a main body 110, a garage door opening button 120 disposed on the main body 110 to open the garage door when the garage door opening button 120 is pressed, a garage door closing button 130 disposed on the main body 110 to close the garage door when the garage door closing button 130 is pressed, and a fingerprint scanner 140 disposed on the main body 110 to prevent the garage door opening button 120 from opening the garage door unless an authorized fingerprint is detected by the fingerprint scanner 130.

The present general inventive concept may include a secured garage door opener 100 to open a garage door, the secured garage door opener 100 including a main body 110, a garage door opening button 120 disposed on the main body 110 to open the garage door when the garage door opening button 120 is pressed, a garage door closing button 130 disposed on the main body 110 to close the garage door when the garage door closing button 130 is pressed, and a camera 150 disposed on the main body 110 to prevent the garage door opening button 120 from opening the garage door unless an authorized face is detected by the camera 150.

A main purpose of the present general inventive concept is to provide users with an advanced security system for garage doors that requires personal verification prior to utilization. Ingenious and practical, the present general inventive concept offers a modern alternative security option that prevents burglars from breaking and entering into a home through the garage and ensures that only authorized individuals have access to this specific home entry. Expanding on the initial design of a standard automotive rear view mirror, the present general inventive concept introduces a novel multi-factor authentication process that allows users to open the garage door from the convenience of their car, guaranteeing a secure and foolproof method of entry into a garage. At the core of the present general inventive concept is its advanced facial recognition feature and this state-of-the-art technology analyzes unique facial characteristics, granting access only to confirmed individuals eliminating the possibility of unauthorized entry. For added security and flexibility, this avant-garde system offers alternative authentication methods whereas users can opt for fingerprint identification or input a personalized code via a touch-pad; ultimately, all these factors ensures that only those with verified fingerprints, programmed facial identifiable records and/or knowledge of a personalized code can gain access to the garage of a house that employs this security control panel. The present general inventive concept takes into account the need for secure access from within a vehicle to eliminate the stress of a thief gaining unauthorized access by simply pushing a button on a remote or from a car parked outside or a standard button, prompt system that is easily accessible on the exterior of a home. This innovative, top-quality product is intended to provide peace of mind and high-level protection for a garage; thus, it may prove to be essential in the safety and commercial industry.

The present general inventive concept is the only product of its kind that requires facial recognition, fingerprint identification, or entry of a personalized code, to ensure that only authorized individuals can open the garage door from the convenience of their car. This unprecedented product is uniquely designed with cutting-edge technology, durable, high-quality materials to ensure long-term sustainability and can be implemented in varying car makes and models, whether at pre-manufacture or post-build.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A secured garage door opener to open a garage door, the secured garage door opener comprising:
a main body;
a garage door opening button disposed on the main body to open the garage door when the garage door opening button is pressed;
a garage door closing button disposed on the main body to close the garage door when the garage door closing button is pressed; and
a fingerprint scanner disposed on the main body to prevent the garage door opening button from opening the garage door unless an authorized fingerprint is detected by the fingerprint scanner.

2. A secured garage door opener to open a garage door, the secured garage door opener comprising:
a main body;
a garage door opening button disposed on the main body to open the garage door when the garage door opening button is pressed;
a garage door closing button disposed on the main body to close the garage door when the garage door closing button is pressed; and
a camera disposed on the main body to prevent the garage door opening button from opening the garage door unless an authorized face is detected by the camera.
